(19) United States
(12) Patent Application Publication
(10) Pub. No.: US 2020/0101543 A1
(43) Pub. Date: Apr. 2, 2020

(54) Attachment for oscillating tool and method thereof

(71) Applicant: LES SALLES DE BAIN D.L. INC., Cap-Saint-Ignace (CA)

(72) Inventors: Daniel Cloutier, Cap-Saint-Ignace (CA); Michael Cloutier, Cap-Saint-Ignace (CA)

(21) Appl. No.: 16/591,465

(22) Filed: Oct. 2, 2019

Related U.S. Application Data
(60) Provisional application No. 62/740,087, filed on Oct. 2, 2018.

(51) Int. Cl. B23D 61/00; B25F 3/00; E04D 15/02

(52) U.S. Cl. CPC B23D 61/006; E04D 15/02; B25F 3/00

(57) ABSTRACT

The invention is directed to an attachment for an oscillating or reciprocating tool. More specifically, the attachment is used to cut shingle. The attachment comprises a cutting portion comprising an attachment member adapted to be received by a head of the oscillating tool. The attachment also comprises a guiding portion operatively connected to the cutting portion. The guiding portion comprises at least one winglet defining a surface substantially parallel to the cutting portion and located at a pre-determined distance from the cutting portion. In use, the at least one surface is in contact with a guiding surface and trims material that exceeds the pre-determined distance as the tool is moved forward and parallel to the reference surface.

### CROSS-REFERENCE TO RELATED APPLICATIONS

The present patent application claims the benefits of priority of U.S. Provisional Patent Application No. 62/740,087, entitled “ATTACHMENT FOR OSCILLATING TOOL AND METHOD THEREOF”, and filed at the United States Patent and Trademark Office on Oct. 2, 2018, the content of which is incorporated herein by reference.

### FIELD OF THE INVENTION

The present invention generally relates to blades and accessories adapted to be used by oscillating or reciprocating power tools. More specifically, the present invention relates to a blade to cut shingle or other materials.

### BACKGROUND OF THE INVENTION

Reciprocating or oscillating tools are commonly used in the field of construction. Such tools employ side to side vibratory motion to cut or work upon materials. Typically, a rear portion of the accessory, or blade, is connected to the head of the tool which induces a movement to the front portion of the blade. Such tools are described in more detailed in U.S. Pat. No. 9,242,361 and in United States Patent Application Publication no. US 2016/0185003.

Oscillating power tools are typically sufficiently light to be handheld. The head is adapted to receive a plurality of attachments to achieve different purposes. Examples of such attachments are described in United States Patent Application Publication no. US 2016/0082605 and in U.S. Pat. No. 9,027,452.

Those tools may be used to trim a portion of a shingle sheet that trespasses the structure of the roof. Using prior art attachments, the user is required to measure and draw a line that he will follow when using the tool to cut the excess material.

There is thus a need to provide an improved attachment for oscillating tools that may be used to precisely and efficiently trim excess material.

### SUMMARY OF THE INVENTION

An object of the invention provides, in accordance with at least one embodiment thereof, a cutting tool configured for use with a oscillating tool, the cutting tool being adapted to cut a shingle with the oscillating action of the tool and with a predetermined distance from an edge of a roof or a building structure, the predetermined distance being set with a guiding portion extending from the tool.

An object of the invention provides, in accordance with at least one embodiment thereof, an attachment for an oscillating tool, the attachment comprising:
a cutting portion comprising an attachment member adapted to be received by a head of the oscillating tool; and
a guiding portion connected to the cutting portion, the guiding portion defining at least one surface substantially parallel to the cutting portion and located at a pre-determined distance from the cutting portion,
   whereby in use the at least one surface is in contact with a guiding surface and the cutting portion trims excess material to leave a tab of material of a length corresponding to the pre-determined distance.

Another object of the invention provides, in accordance with at least one embodiment thereof, a method of trimming excess material using an attachment operatively connected to an oscillating tool, the method comprising the steps of:
creating a contact between a reference surface and a surface of a guiding portion of the attachment, the surface being substantially parallel to a cutting portion of the attachment and located at a pre-determined distance from the cutting portion; and
moving the tool in a direction parallel to the reference surface thereby trimming excess material to leave a tab of material of a length corresponding to the pre-determined distance.

In yet another aspect of the invention, an attachment for an oscillating tool is provided. The attachment comprises a body, a cutting portion disposed in the body, an attachment portion disposed in the body for securing the oscillating tool and a guiding portion axially disposed at a distance from the cutting portion for axially locating the cutting portion. The cutting portion may comprise a series of cutting elements. The cutting portion may further comprise a cavity including the series of cutting elements. The cavity may include a pair of opposed series of teeth. The cavity may include an acute angled opening.

The body may be made of hardened sheet metal material. The attachment portion may comprise a main aperture disposed in the body about an aperture axis for securing the oscillating tool. The guiding portion may include at least one of winglet disposed at an axial distance from the cutting portion. The at least one winglet may be a pair of winglets respectively disposed at different axial distances from the cutting portion. The attachment portion may further be adapted to cut shingles with a predetermined distance from a reference object, the predetermined distance being provided by the winglet axial distance from the cutting portion.

In a further aspect of the invention, an oscillating tool comprising a cutting tool is provided. The oscillating tool comprises a body, a cutting portion disposed in the body, a main aperture disposed in the body about an aperture axis and a guiding portion axially disposed at a distance from the cutting portion for axially locating the cutting portion.

The cutting portion may further comprise a cavity including the series of cutting elements. The cavity may include a pair of opposed series of cutting elements.

The body may be made of hardened sheet metal material. The guiding portion may comprise at least one of winglet disposed at an axial distance from the cutting portion.

The at least one winglet may be a pair of winglets respectively disposed at different axial distances from the cutting portion. The attachment portion may be adapted to cut shingles with a predetermined distance from a reference object, the predetermined distance being provided by the winglets axial distance from the cutting portion. The winglet may be movable with regards to the body.

In yet another aspect of the invention, a method to trim material is provided. The method comprises securing an attachment to an oscillating tool, the attachment comprising a body, a cutting portion disposed in the body, an attachment portion disposed in the body and a guiding portion axially disposed at a distance from the cutting portion for axially locating the cutting portion. The method further comprises contacting the guiding portion to a reference object, engaging the material with the cutting portion, oscillating the attachment with the oscillating tool and moving the attachment toward the material while maintaining contact between the guiding portion and the reference object to trim excess material further extending from the axial location of the cutting portion. The method may further comprise aligning the material with a concave opening of the cutting portion.

Other and further objects, aspects and advantages of the present invention will be obvious upon an understanding of the illustrative embodiments about to be described or will be indicated in the appended claims, and various advantages not referred to herein will occur to one skilled in the art upon employment of the invention in practice.

### BRIEF DESCRIPTION OF THE DRAWINGS

The above and other aspects, features and advantages of the invention will become more readily apparent from the following description, reference being made to the accompanying drawings in which:

FIG. 1 is a side view of the attachment in accordance with the principles of the present invention;

FIG. 2 is top view of the attachment of FIG. 1;

FIG. 3 is a front view of the attachment of FIG. 1; and

FIG. 4 is a front view of the attachment of FIG. 1 showing the attachment in use.

### DETAILED DESCRIPTION OF THE PREFERRED EMBODIMENT

A novel attachment for oscillating tool will be described hereinafter. Although the invention is described in terms of specific illustrative embodiments, it is to be understood that the embodiments described herein are by way of example only and that the scope of the invention is not intended to be limited thereby.

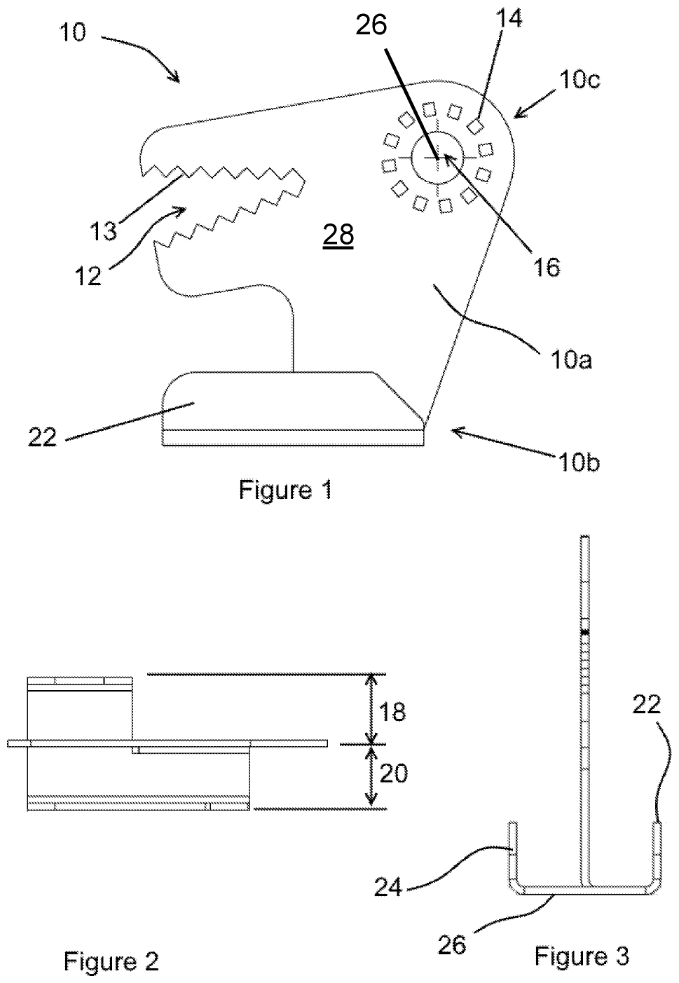

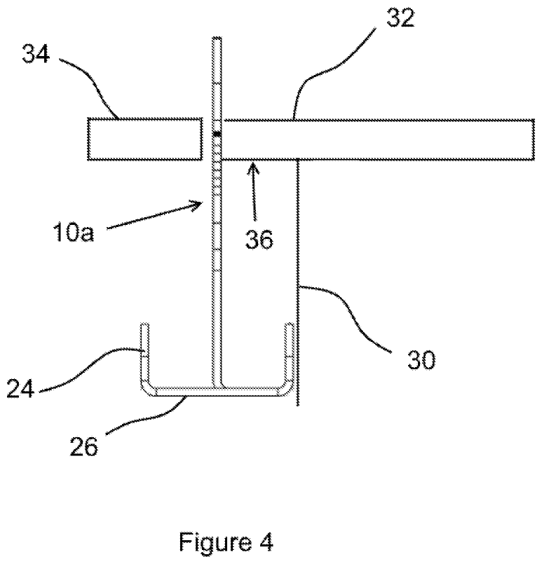

Referring to FIGS. 1 to 4, an attachment 10 is typically made of rigid or semi-rigid material, such as but not limited to metal sheet. Understandably, any other suitable material known in the art and having sufficient mechanical properties to achieve the material cutting may be used without departing from the scope of the present description. The attachment 10 comprises a body 10a and a guiding portion 10b. The body 10a comprises a cutting portion 28 including a generally concave opening 12 and may further comprise cutting teeth 13 that could be embodied as a pair of series of opposed teeth 13. The body 10a also comprises an attachment portion 10c. The attachment portion 10c comprises a main aperture 16 and peripheral apertures 14 disposed at equal distance from one another and defining a circle coincident with the main aperture 16 about an aperture axis 26 thereof. Such exemplary attachment portion 10c is known in the art and is adapted to be received by a reciprocating tool including a corresponding securing mechanism (not shown). Understandably, any other attachment member suitable to connect an attachment tool 10 to an oscillating tool may be used without departing from the scope of the invention.

The attachment 10 also includes the guiding portion 10b disposed at a predetermined distance from the main aperture 16. In a preferred embodiment, the guiding portion 10b comprises two opposite winglets 22 and 24 attached together via a base plate 26. The base plate 26 is preferably perpendicular to the body 10a and perpendicular to the winglets 24 and 26. However, in other embodiments, the base plate 26 may have a different angle and distance in relation to the body 10a plan and the main aperture 16.

The winglets 24 and 26 are spaced away from the body 10a by predetermined distances 18 and 20, respectively. The distance 18 may be equal or different than the distance 20. In a preferred embodiment, the distances 18 and 20 are both of about 12.5 millimeters (about 0.5 inch).

In other embodiments (not shown), the guiding portion 10b may comprise only one winglet 22 or 24.

In use, the winglet 22 or 24 is adapted to be in contact with a guiding surface 30. The guiding surface 30 can be an edge of a roof or a building structure that is followed to keep a constant distance between the body 10a and the edge of the roof. The body 10a will thus trim excess materials 34 of original materials 32 to leave a tab 36 of a length corresponding to the distance 18 or 20.

In another possible embodiments, the winglets 22 and 24 may be movable with regards to the body 10a as to vary the distance 18 and 20. In such an embodiment, any mean known in the art to adjust distance between two parts could be used.

A method to trim excess material 34 using an attachment 10 operatively connected or mounted to an oscillating tool is provided. The method comprises a step of creating a contact between a reference or guiding surface 30 and a tool contact surface, or winglet 22, 24 of the guiding portion 10b of the attachment 10. Preferably, the guiding surface 30 is substantially parallel to a body 10a of the attachment 10 and is preferably located at a pre-determined distance 18 or 20 from the cutting portion 10a.

The method further comprises the step of moving the tool in a direction generally parallel to the reference surface 30 thereby trimming excess material 34 of original materials 32 to leave a tab of material 36 of a length corresponding to the pre-determined distance 18 or 20.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1. An attachment for an oscillating tool, the attachment comprising:
a body;
a cutting portion disposed in the body;
an attachment portion disposed in the body for securing the oscillating tool; and
a guiding portion axially disposed at a distance from the cutting portion for axially locating the cutting portion.

2. The attachment for an oscillating tool of claim 1, wherein the cutting portion comprises a series of cutting elements.

3. The attachment for an oscillating tool of claim 2, wherein the cutting portion further comprises a cavity including the series of cutting elements.

4. The attachment for an oscillating tool of claim 3, wherein the cavity includes a pair of opposed series of teeth.

5. The attachment for an oscillating tool of claim 3, wherein the cavity includes an acute angled opening.

6. The attachment for an oscillating tool of claim 1, wherein the body is made of hardened sheet metal material.

7. The attachment for an oscillating tool of claim 1, wherein the attachment portion comprises a main aperture disposed in the body about an aperture axis for securing the oscillating tool.

8. The attachment for an oscillating tool of claim 1, wherein the guiding portion includes at least one of winglet disposed at an axial distance from the cutting portion.

9. The attachment for an oscillating tool of claim 8, wherein the at least one winglet is a pair of winglets respectively disposed at different axial distances from the cutting portion.

10. The attachment for an oscillating tool of claim 8, wherein the attachment portion is adapted to cut shingles with a predetermined distance from a reference object, the predetermined distance being provided by the winglet axial distance from the cutting portion.

11. An oscillating tool comprising a cutting tool comprising:
a body;
a cutting portion disposed in the body;
a main aperture disposed in the body about an aperture axis; and
a guiding portion axially disposed at a distance from the cutting portion for axially locating the cutting portion.

12. The oscillating tool of claim 11, wherein the cutting portion further comprises a cavity including the series of cutting elements.

13. The oscillating tool of claim 12, wherein the cavity includes a pair of opposed series of cutting elements.

14. The oscillating tool of claim 11, wherein the body is made of hardened sheet metal material.

15. The attachment for an oscillating tool of claim 11, wherein the guiding portion includes at least one of winglet disposed at an axial distance from the cutting portion.

16. The attachment for an oscillating tool of claim 16, wherein the at least one winglet is a pair of winglets respectively disposed at different axial distances from the cutting portion.

17. The attachment for an oscillating tool of claim 16, wherein the attachment portion is adapted to cut shingles with a predetermined distance from a reference object, the predetermined distance being provided by the winglets axial distance from the cutting portion.

18. The attachment for an oscillating tool of claim 16, the winglet being movable with regards to the body.

19. A method to trim material, the method comprising:
securing an attachment to an oscillating tool, the attachment comprising:
a body;
a cutting portion disposed in the body;
an attachment portion disposed in the body; and
a guiding portion axially disposed at a distance from the cutting portion for axially locating the cutting portion;
the method further comprising contacting the guiding portion to a reference object;
engaging the material with the cutting portion;
oscillating the attachment with the oscillating tool; and
moving the attachment toward the material while maintaining contact between the guiding portion and the reference object to trim excess material further extending from the axial location of the cutting portion.

20. The method of claim 19, the method further comprising aligning the material with a concave opening of the cutting portion.
